(19) United States
(12) Patent Application Publication
(10) Pub. No.: US 2011/0047802 A1
(43) Pub. Date: Mar. 3, 2011

(54) Cut blocker

(75) Inventor: Sandra Kay Long, Bronx, NY (US)

(73) Assignee: SANDRA KAY LONG, BRONX, NY (US)

(21) Appl. No.: 12/800,753

(22) Filed: May 21, 2010

Related U.S. Application Data
(60) Provisional application No. 61/181,732, filed on May 28, 2009.

(51) Int. Cl. B26B 13/00

(52) U.S. Cl. 30/233

(57) ABSTRACT

This blocker attachment unit fits snugly onto and covers the existing stopper of a hair cutting scissor. The blocker attachment is a snap-on unit that is removable. It will annex the existing stopper when it is fixed in place. The blocker attachment functions in cooperation with scissors that have an existing stopper but, prospectively the units can also be attached to many other types, style and designs of scissors.

### FIELD OF THE INVENTION

This invention relates to cosmetology; generally hairstylist, but particularly student learners. This blocker attachment is a physical and existing method of prevention aiding against any affiliation or occurrence resulting from someone snipping, nicking or cutting themselves with a haircutting scissor while cutting the hair.

### BACKGROUND AND STATEMENTS

I am a licensed cosmetologist and hairstylist, with over 25 years of experience in this industry. I am presently employed as an educator at a beauty school. I am alarmed at how often the student learners repeatedly cut themselves with their scissors time and time again. Before actually practicing haircutting techniques the student learners are presented with the theory and principles for cutting hair safely and accurately. Systematically, they are educated on preventative methods explaining how to not cut themselves with their scissors. The scientific and mathematical method of prevention that is expressed to them is not to cut pass the second knuckle of their middle finger and to only use ⅓ to ½ of the scissor's cutting blade when cutting hair. No matter how often the student learners are instructed to do so, some continuously snip and cut themselves. The kinesthetic learners or someone who has little to no experience with hair cutting, have not yet mastered dexterity. He or she mainly focuses on cutting the section of hair that is held between their fingers. They do not focus nor concentrate on the fact that the scissor's cutting blade may be too close to their fingers or too far upward into their palm. Until the student learner can systematically visualize the principle methodical theory for cutting correctly, prospectively they will have a physical and existing method that will prevent him/her from cutting themselves. My sorted out conclusion is a Cut Blocker unit, an attachment that will disable the scissors from closing completely at the ends or beyond the second knuckle on middle finger. The blocker attachment will physically enable the use of only ⅓ to ½ of the scissor's cutting blade. The student learner can feel a sense of security because he/she will be spared the painful blood spilling consequences resulting from the snips and cuts that may be encountered when using their scissors.

### BRIEF DESCRIPTION OF DRAWING

FIG. 1 A picture featuring the invented attachment, open at the bottom and hollowed.

FIG. 2 A picture of an existing hair cutting scissor that is closed viewing the position and the function of the Scissor's stopper.

FIG. 3 A picture showing how the featured blocker attachment is to be placed over and snapped onto, covering the existing stopper.

FIG. 4 A view of the featured blocker in place annexing the stopper while raising the height above the stopper the relative and significant fraction of an inch higher on the closed position.

### SPECIFICATION AND FUNCTION

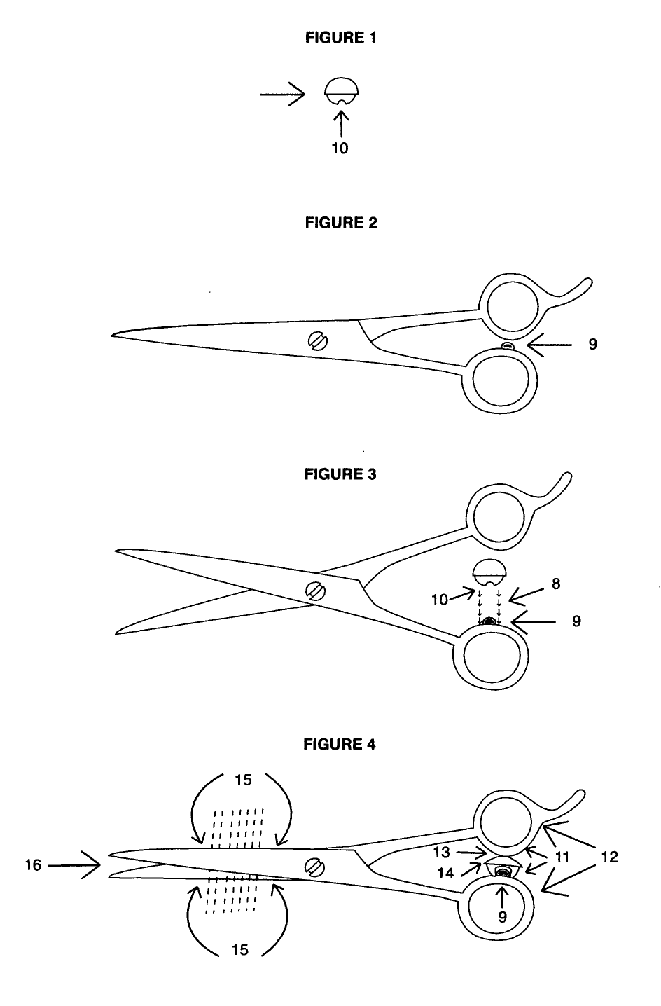

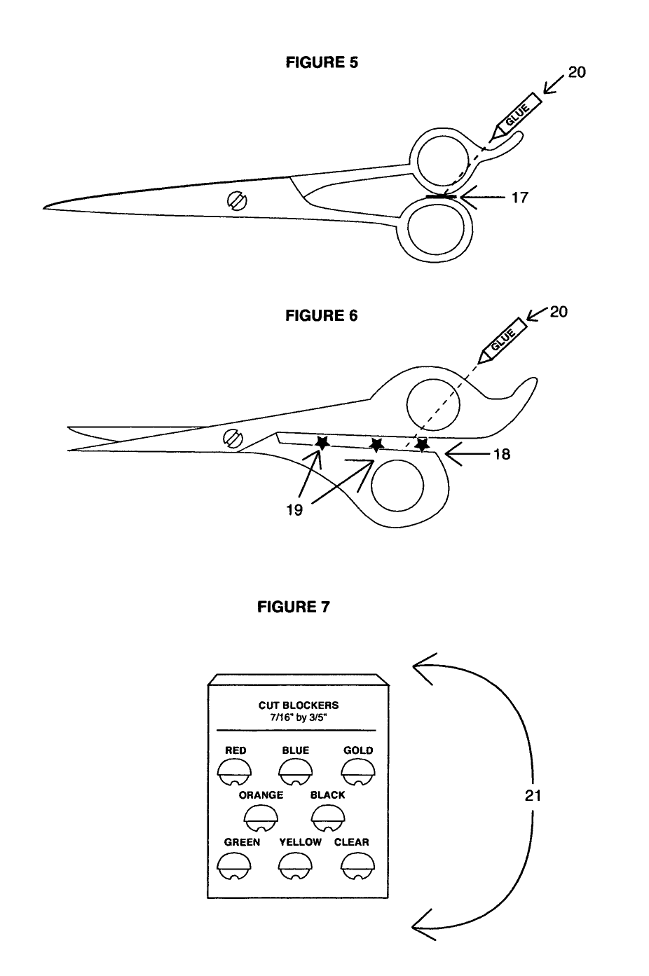

(FIGS. 3 and 4) show how the 8 invented attachment will fit in place 14 annexing the 9 existing stopper. The 10 featured attachment is open at the, bottom and hollowed, (FIG. 4) its intended purpose is 11 to increase the distances between the 12 finger grips and 13 decreases the distance above the existing stopper when 13 close contact is made. The attachment is a 14 significant fraction of an inch higher, then the 9 stopper, therefore the scissors 15 cutting blades will not meet together 16 completely at the ends (the tips) when cutting the hair. (resulting a no nick or nips from the end of the scissor resolution.) Only the 15 upper half of the scissors cutting blade is involved and is enabled enough contact to cut the hair. (FIGS. 5 and 6) The units are reusable and may be attached to other types or styles of scissor. For examples, scissors with stopper size different, scissors 17 without jutting stopper or scissor with 18 flat shanks, you would then attach the blocker units in 19 position of choice with a small amount of 20 bonding agent. Both bonding agent and attachment may be removed when ready with remover. (FIG. 1) The average Cut Blocker unit is approx. 7/16 of an inch high and ⅗ of an inch in diameter, 10 hollowed and open at the bottom.

1. My invention is a physical and existing method to cut prevention, it is a snap on attachment designed for scissors that will annex the existing stopper and function as a Blocker.
My Cut Blocker unit is a tangible method of cut prevention that will spare the student learner from painful and blood spill consequences resulting from the nicks and cuts that may be encountered while learning to use their scissor correctly. Therefore, hygienically promoting health and cleanliness to the associating environment.
My Cut Blocker unit will provide the inexperienced haircutter a feeling of security. He/She will no longer be afraid of cutting themselves, because this will be a painful incidental occurrence that is now in their past.
My Cut Blocker is innovative. This is a new impression for the student's scissor that also physically corresponds technically with the scientific and mathematical theory behind cutting the hair safely. Therefore, the visual and kinesthetic learners can receive tangible knowledge which will help him/her grasp the concept easier behind cutting the hair safely.
My Cut Blocker units will come in various colors such as, blue, yellow, green, clear, black, gold, red, and orange. My designed blocker units will come in various sizes ranging from minimum to maximum height base on every scissors size differences.
My Cut Blocker units will also come in various sizes ranging from minimum to maximum in diameter based on every scissor sizes and styles differences, as so to be widely accommodating and adaptable to all sizes style and type of scissors.
My Cut Blocker units are made of acrylic and hard rubber. These are made to snap on and snap off.
